(19) United States
(12) Patent Application Publication
(10) Pub. No.: US 2017/0046773 A1
(43) Pub. Date: Feb. 16, 2017

(54) METHODS AND SYSTEMS FOR AUTOMATIC REORDERING OF PREVIOUSLY ORDERED PRODUCTS

(71) Applicant: Wal-Mart Stores, Inc., Bentonville, AR (US)

(72) Inventors: Braxton S. Hendricks, II, Springdale, AR (US); Kendra Bluhm, Seligman, MO (US); Jeffrey D. Thiessen, Bentonville, AR (US); Leon K. Hui, Houston, TX (US); Pranay K. Chavva, Rogers, AR (US)

(21) Appl. No.: 15/232,117

(22) Filed: Aug. 9, 2016

Related U.S. Application Data
(60) Provisional application No. 62/205,563, filed on Aug. 14, 2015.

(51) Int. Cl. G06Q 30/06

(52) U.S. Cl. CPC G06Q 30/0635

(57) ABSTRACT

In some embodiments, methods and systems of assisting a consumer in automatically reordering previously ordered products using an electronic computing device include displaying account information of the consumer from the consumer information database in a graphical product reorder interface on the electronic computing device. The displayed account information of the consumer includes a reorder shopping list including at least one product previously ordered by the consumer and product reorder settings of the consumer associated with the at least one product previously ordered by the consumer. The consumer is permitted to modify the product reorder settings of the consumer via at least one input field on the graphical product reorder interface displayed on the electronic computing device and the at least one previously ordered product on the reorder shopping list is automatically reordered based on the product reorder settings of the consumer.

### CROSS-REFERENCE TO RELATED APPLICATION

This application claims the benefit of U.S. Provisional Application No. 62/205,563, filed Aug. 14, 2015, and is incorporated herein by reference in its entirety.

### TECHNICAL FIELD

This invention relates generally to reordering products previously ordered by a consumer and, in particular, to systems and methods for automatically reordering products previously ordered by the consumer based on consumer-specified product reorder settings.

### BACKGROUND

Consumers often reorder previously ordered products. Some products that are commonly reordered may include, for example, household items (e.g., cleaning supplies, soap, shampoo, toothpaste, etc.), office supplies (e.g., paper, ink, pens, pencils), prescription and over-the-counter medication, and dietary supplements just to name a few. Consumers often initially order a product on a website operated by a retail provider (e.g., Walmart/Sams Club) by browsing for the product of interest, adding the product of interest to a virtual shopping cart on the retail provider's website, then proceeding to checkout by providing a payment method (e.g., credit card information) to purchase the product in the shopping cart.

One disadvantage of such website-based product ordering systems is that while the consumers' purchase history is typically available on the retail provider's website, when a need arises for the consumers to reorder a previously ordered product, the consumers typically have to again manually go through the time-consuming multi-step ordering process on the retail provider's website described above (i.e., browse for and select a product, add the product to the virtual shopping cart, and pay for the product in the virtual shopping cart at checkout). Another disadvantage of conventional retail websites is that the decision of when to reorder a previously ordered product is left up to the consumers and the consumers are often too busy to remember and as a result do not timely reorder the product via the retail website originally used to purchase the product, often leading the consumers to not reorder the product from the original online retail website, but to rush to a local brick-and-mortar retail facility to buy the product.

### BRIEF DESCRIPTION OF THE DRAWINGS

Disclosed herein are embodiments of systems, apparatuses and methods pertaining to systems and methods for automatically reordering products previously ordered by the consumer based on consumer-specified product reorder settings. This description includes drawings, wherein:

FIG. 1 is a diagram of a system for automatically reordering products for a consumer in accordance with some embodiments.

FIG. 2 is a functional diagram of an exemplary electronic computing device usable with the system of FIG. 1 in accordance with several embodiments.

FIG. 3 is a flow chart operational diagram of a system for automatically reordering products for a consumer in accordance with some embodiments.

FIG. 4 is a flow chart diagram of a process of automatically reordering products for a consumer in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems and methods are provided for automatically reordering products previously ordered by the consumer based on consumer-specified product reorder settings.

In one embodiment, a method for assisting a consumer in automatically reordering previously ordered products using an electronic computing device includes displaying account information of the consumer from a consumer information database in a graphical product reorder interface on the electronic computing device. The displayed account information of the consumer includes a reorder shopping list including at least one product previously ordered by the consumer and product reorder settings of the consumer associated with the at least one product previously ordered by the consumer. The method further includes permitting the consumer to modify the product reorder settings of the consumer via at least one input field on the graphical product reorder interface displayed on the electronic computing device and automatically reordering the at least one previously ordered product on the reorder shopping list based on the product reorder settings of the consumer.

In another embodiment, a system for assisting a consumer in automatically reordering previously ordered products includes a consumer information database configured to store consumer information and an electronic computing device including a processor and configured to communicate with the consumer information database via a communication network. The electronic computing device is configured to: retrieve account information of the consumer from the consumer information database; display the account information of the consumer received from the consumer information database in a graphical product reorder interface. The displayed account information of the consumer includes: a reorder shopping list including at least one product previously ordered by the consumer and product reorder settings of the consumer associated with the at least one product previously ordered by the consumer. The electronic computing device is further configured to permit the consumer to modify the product reorder settings of the consumer via at least one input field on the displayed graphical product reorder interface and to automatically reorder the at least one previously ordered product on the reorder shopping list based on the product reorder settings of the consumer.

In yet another embodiment, a system for assisting a consumer in automatically reordering previously ordered products includes a database means configured to store consumer information and a processing means configured to communicate with the consumer information database via a communication network. The processing means is configured to retrieve account information of the consumer from the consumer information database and display the account information of the consumer received from the consumer information database in a graphical product reorder interface. The displayed account information of the consumer includes a reorder shopping list including at least one product previously ordered by the consumer and product reorder settings of the consumer associated with the at least one product previously ordered by the consumer. The processing means is further configured to permit the consumer to modify the product reorder settings of the consumer via at least one input field on the displayed graphical product reorder interface and to automatically reorder the at least one previously ordered product on the reorder shopping list based on the product reorder settings of the consumer.

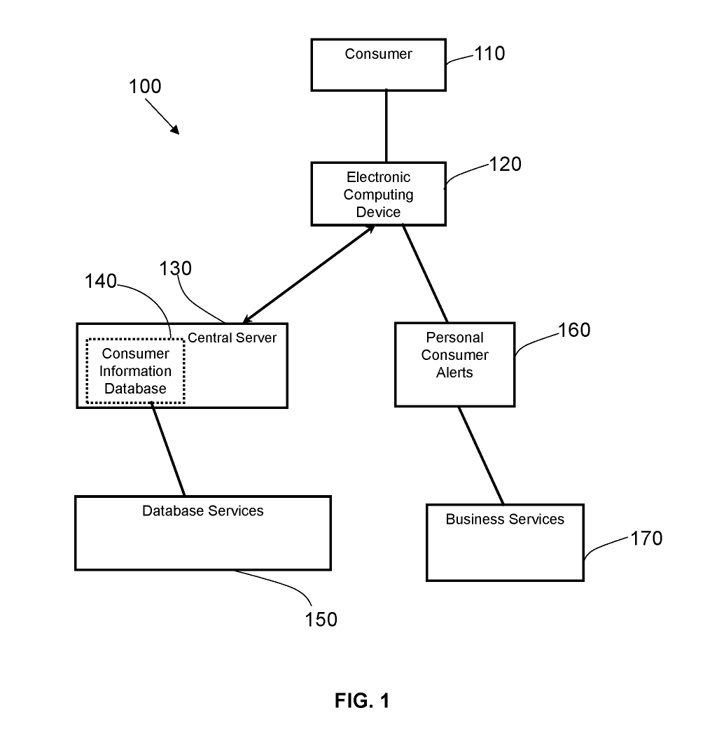

Referring to FIG. 1, one embodiment of a system 100 for assisting a consumer 110 in automatically reordering products previously ordered by the consumer 110 from a retail provider. The retail provider may be any place of business such as a retail store or warehouse having a brick-and-mortar physical location and/or a retail website accessible via the interne through which consumer products may be ordered and reordered by the consumer 110. Exemplary products that may be ordered by the consumer 110 and automatically reordered for the consumer 110 via the system 100 may include, but are not limited to general-purpose consumer goods as well as consumable items such as medications, food items, and dietary supplements.

The exemplary system 100 depicted in FIG. 1 includes an electronic computing device 120 available to the consumer 110 and configured to receive and/or transmit information regarding one or more products to be ordered by the consumer 110 and/or previously ordered by the consumer 110 and/or to be reordered for the consumer 110 from the retail provider. In some embodiments, the electronic computing device 120 may be a stationary, portable, and/or hand-held consumer personal electronic device, for example, a desktop computer, a laptop computer, a tablet, a mobile phone, or any other electronic, processor-based device that may be configured for data entry and communication with another electronic, processor-based device located either at a brick-and-mortar location of the retail provider, or at a location remote to the brick-and-mortar location of the retail provider (e.g., at a retail provider's regional or central location).

In some embodiments, instead of being a consumer personal electronic device 120 as described above, the electronic computing device 120 may be a stationary or portable electronic device installed or otherwise operatively connected at the brick-and-mortar location of the retail provider. Examples of electronic computing devices installed or otherwise operatively connected at the brick-and-mortar location of the retail provider may include but are not limited to a kiosk or a kiosk-type computing station available to a consumer 110 at the brick-and-mortar sales facility of the retail provider, mounted product scanner, and or another electronic computing device configured to permit a consumer to scan a product at the retail sales facility.

The exemplary system 100 shown in FIG. 1 includes a central server 130 in two-way communication with the electronic computing device 120 via a connection 125. The connection 125 may be a wired or wireless connection. The central server 130 may be implemented as one server at one location (e.g., at the retail provider's brick-and-mortar retail facility or at a location specifically dedicated to server storage). Alternatively, the central server 130 may be implemented as multiple interconnected servers stored at one or more locations.

The central server 130 may include a consumer information database 140, as shown in FIG. 1. In some embodiments, the consumer database 140 may be configured to store information associated with a consumer 110 who orders and reorders products from the retail provider. It will be appreciated that the consumer information database 140 on the central server 130 may also store information pertaining to the inventory available to the consumer 110 for purchase from the retail provider. In addition, while the central server 130 is illustrated in FIG. 1 as including one database 140, it will be appreciated that the central server 130 may include two or more databases configured to store consumer information and/or product inventory information.

The consumer information database 140 may be stored, for example, on non-volatile storage media (e.g., a hard drive, flash drive, or removable optical disk) internal or external to the central server 130, or internal or external to computing devices separate and distinct from the central server 130. In some embodiments, the information stored in the consumer database 140 may relate to personal information of the consumer 110 and/or product order history of the consumer 110, and/or product reorder settings of the consumer, and/or other information of interest to the consumer 110, which will be discussed in more detail below.

While the central server 130 may be in direct two-way communication with the electronic computing device 120 via the connection 125 as shown in FIG. 1, it will be appreciated that the electronic computing device 120 may be in indirect two-way communication with the central server 130 via one or more intermediate servers or other communication devices. It will likewise be appreciated that the system 100 may be confined to a single brick-and-mortar location of the retail provider such that neither the electronic computing device 120 nor the central server 130 is required to communicate with a device or server remote to the brick-and-mortar location of the retail provider.

As shown in FIG. 1, the exemplary central server 130, which includes the consumer information database 140, is configured to provide a variety of database services 150 to the consumer 110. Exemplary database services 150 that the central server 130 may be configured to provide include but are not limited to: Savings Catcher, ISB, Grocery Home Shopping, PuT, SFS, Express Stores, Click N Pull, Data Warehouse, S2S, Rx, TLE, Specialty, Expanded Assortment, and Market Basket. Each of these is briefly described below.

Savings Catcher refers to a service configured to compare the price paid for a product by the consumer 110 on the retail provider's website or at the retail provider's brick-and-mortar location, and upon a determination that an advertised price of a competitor of the retail provider is lower than the price the consumer 110 paid for the product to the retail provider, the Savings Catcher service is configured to provide an electronic gift card to the consumer 110 as reimbursement for the price difference.

ISB or instant savings book refers to a service configured to provide the consumer 110 with instant savings on selected products in the catalog of the retail provider when the consumer 110 purchases such product at checkout.

Grocery Home Shopping or Delivery To Go refers to a service configured to permit the consumer 110 to order one or more grocery products of interest using the electronic computing device 120 (e.g., while being at home or at another location remote to a brick-and-mortar retail facility of the retail provider), and get the ordered grocery product or products delivered to the home of the consumer 110 or another location specified by the consumer 110.

PuT (Pick Up Today application) refers to a service configured to allow the consumer 110 to order online, using the electronic computing device 120, one or more products available at the brick-and-mortar location, and then request a pick up time (e.g., by designating a time window for pick up). The retail provider will then gather the products ordered by the customer and have the products ordered by the consumer 110 ready for the consumer 110 to pick up at the brick-and-mortar location inside the time window designated by the consumer 110.

SFS (Ship from Store) refers to a service configured to permit the consumer 110 to order one or more products of interest from a website of the retail provider using the electronic computing device 120 and get the ordered product or products delivered to the home of the consumer 110 from a brick-and-mortar retail facility of the retail provider nearest to the home of the consumer 110 instead of from a more remote central or regional distribution center of the retail provider.

Express Stores refers to small-sized brick-and-mortar grocery retail facilities operated by a retail provider to permit the consumer 110 to order grocery items or other daily essentials and convenience products.

Click N Pull refers to a service configured to permit the consumer 110 order one or more products on a website of the retail provider while selecting a brick-and-mortar retail facility of the retail provide for picking up the product or products ordered by the customer 110, after which the products ordered by the consumer 110 are pulled (e.g., by a stocking or sales associate) from the shelves or the stock room at the retail provider's brick-and-mortar retail facility selected by the consumer 110 and held for pick up by the consumer 110.

Data Warehouse refers to one or more databases configured for electronic storage of a large amount of information of a retail provider. Warehoused data is preferably stored in a manner that is secure, reliable, easy to retrieve and easy to manage. The warehoused data can be used by the retail provider for various purposes such exploration and data mining and looking for patterns of information that will help improve business. A data warehouse can be a relational database that is designed for query and analysis rather than for transaction processing and may store historical data derived from transaction data or data from other sources, and may separate analysis workload from transaction workload and enable the retail provider to consolidate data from several sources. In addition to a relational database, a data warehouse environment may include an extraction, transportation, transformation, and loading (ETL) solution, an online analytical processing (OLAP) engine, client analysis tools, and other applications that manage the process of gathering data and delivering the data to retail providers or other users.

S2S (Site to Store) refers to a service configured to permit the consumer 110 to order one or more products on a website of the retail provider while selecting a brick-and-mortar retail location of the retail provider for picking up the ordered products, after which the products ordered by the consumer 110 are delivered (e.g., from the retail provider's warehouse) to the retail provider's brick-and-mortar retail facility selected by the consumer 110 and held for pick up.

Rx—refers to a service configured to permit the consumer 110 to refill multiple medication prescriptions at once; set up auto-refills and reminders for medication prescriptions; generate medical expense reports relating to prescription medication; view prescription order and/or refill history; and/or track order status for prescription medication.

TLE (Tire & Lube Express) refers to a merchandising area of the retail provider relating to auto services. The consumer 110 can order and automatically reorder items and/or services provided by TLE using the systems and methods described herein.

Specialty refers to specialized merchandising areas of the retail provider. Examples of “specialty” may include, but are not limited to, optical, photo, lawn and garden, pharmacy, etc. The items assigned to these specialty departments of the retail provider are available for ordering and automatically reordering by the consumer 110 using the systems and methods described herein.

Expanded Assortment generally refers to a service that goes beyond what a retail provider can offer in brick-and-mortar stores due to spacing or inventorying issues. The consumer 110 may order and automatically reorder the expanded assortment products and/or services of the retail provider using the systems and methods described herein.

Market Basket refers to a service configured to translate the point of sale tlog (transaction log) data into data that can be used for analytics or decision making by other systems. Market Basket may provide point of sale information, such as sale information (items purchased, price paid, etc.), register data (register number, time of purchase, cashier id, etc.) and item information (item description, item price, number of items purchased, etc.)

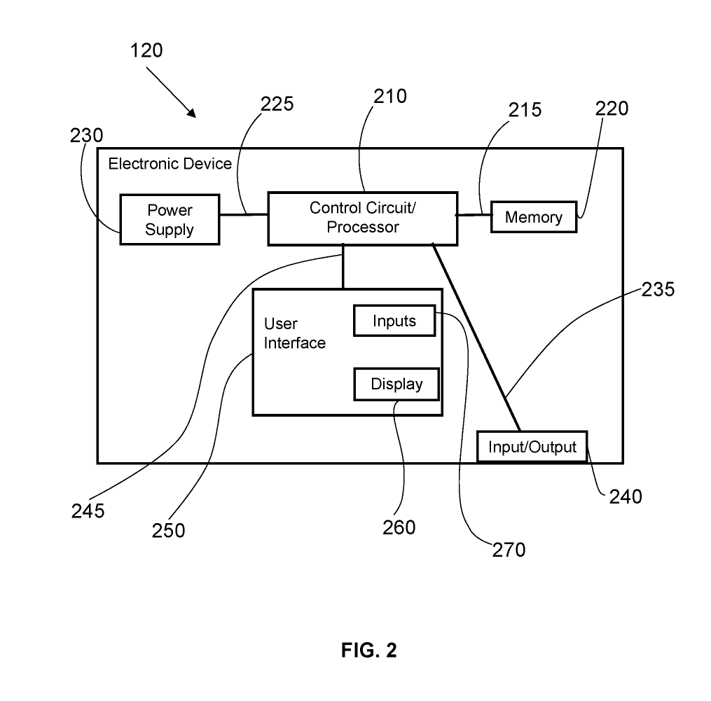

With reference to FIG. 2, an exemplary electronic computing device 120 configured for use with the systems and methods described herein may include a control circuit 210 including a processor (for example, a microprocessor or a microcontroller) electrically coupled via a connection 215 to a memory 220 and via a connection 225 to a power supply 230. The control circuit 210 of the electronic computing device 120 is also electrically coupled via a connection 235 to an input/output 240 that can receive signals from the central server 130 (e.g., data from the consumer information database 140)or from any other source that can communicate with the electronic computing device 120 via a wired or wireless connection. The input/output 240 of the electronic computing device 120 can also send signals to the central server 130 (e.g., data including username/password information of the consumer 310), or to any other device in wired or wireless communication with the electronic computing device 120.

In the embodiment shown in FIG. 2, the control circuit 210 of the electronic computing device 120 is electrically coupled via a connection 245 to a user interface 250, which may include a visual display or display screen 260 (e.g., LED screen) and/or inputs 270 that provide the user interface 250 with the ability to permit a consumer to manually control the electronic computing device 120 by inputting commands via touch-screen and/or button operation and/or voice commands to, for example, add one or more products to the shopping cart of the consumer 110; purchase one or more products added to the shopping cart; and/or configure product reorder settings of the consumer that control automatic reordering of one or more products for the consumer 110 from the retail provider using the system 100.

In some embodiments, the display screen 260 of the electronic computing device 120 is also configured to permit the user to see various graphical interface-based menus, options, and/or alerts that may be displayed to the consumer 110 by the electronic computing device 120 in connection with the consumer 110 modifying and/or updating the product reorder settings of the consumer 110 or other consumer information. The inputs 270 of the electronic computing device 120 may be configured to permit the consumer 110 to navigate through the on-screen menus on the electronic computing device 120 and allow the consumer 110 to change and/or update consumer's product orders and/or product reorder settings as needed. It will be appreciated that the display screen 260 may, in some embodiments, be configured as both a display screen and an input 270 (e.g., a touch-screen that permits the consumer 110 to press directly on the display screen 260 to enter text and/or execute commands.)

In some embodiments, the control circuit 210 of the electronic computing device 120 may be programmed to generate personal consumer alerts 160 in connection with the products that the consumer 110 added to his or her product shopping cart and/or product reorder shopping list for a selected retail provider. The personal alerts 160 may be generated by the electronic computing device 120 based on information received from the central server 130 and/or consumer information database 140 or another location configured to inform the consumer 110 in regards to various events that may be of interest to the consumer 110 and/or actions that may need to be taken by the consumer 110, and/or advertise various business services offered by the retail provider to the consumer 110. Some exemplary personal consumer alerts 160 that may be sent to and displayed by the electronic computing device 120 (e.g., from the central server 130 or another location) may include but are not limited to text messages, electronic mail (e-mail) messages, voice mail messages, and/or electronic catalog information. The personal alerts 160 may be configured as described in more detail below.

In some embodiments, the personal alerts 160 may be configured to inform the consumer 110 regarding various business services 170 offered by the retail provider. The business services 170 that may be offered to the consumer 110 by the retail provider via the personal customer alerts 160 may include but are not limited to: Grocery Items, TLE, Outside Sales, Specialty, Rx (pharmacy), Photo Center, GM, In Club Self Service, Stationary/Office, Customer Support, .com, Optical, POS (QR addition), Restaurant/Small Business, Click n Pull Renewal, and Membership Services. Each of these business services not already described above is described below.

Grocery Items refers to retail provider's offerings of grocery products (at brick-and-mortar locations and online) that may be ordered and automatically reordered by the consumer using the systems and methods described herein.

Outside Sales refers to a service configured to permit the retail provider to offer its products and/or services for sale to a consumer 110 not just within the brick-and-mortar location of the retail provider, but at locations other than the brick-and-mortar location of the retail provider.

Rx (Pharmacy) is a service that permits the consumer to order and automatically reorder prescription and over-the-counter medication as well as other pharmacy-related products and/or services using the systems and methods described herein.

Photo Center is a retail area of the retail provider and permits the consumer to order and automatically reorder photo prints as well as other photo-related products and/or services using the systems and methods described herein.

GM stands for general merchandise and general merchandise products other than perishable or grocery related products that may be ordered and automatically reordered by the consumer 110 using the systems and methods described herein. An example of GM inventory is electronics.

In Club Self Service refers to a service configured to allow the consumer 110 to pick up products from the retail provider once the retail provider has collected the list/inventory of products ordered by the consumer 110. In Club Self Service provides the consumer 110 a convenient location for pick up and storage until the consumer 110 is ready to collect and retrieve the ordered products. The retail provider can gather the products ordered by the consumer 110 and have the products ready for the consumer 110 to pick up inside the time window designated by the consumer 110.

Stationary/Office is a retail area of the retail provider that permits the consumer 110 to order and automatically reordered products such as stationary and office items are those like notepads, pens and pencils, markers, printer/printing supplies, etc. using the systems and methods described herein.

Customer Support refers to an automated or manned area of the retail provider where a consumer 110 can receive help. Customer Support could include a service desk within a brick-and-mortar store of the retail provider, a 1-800 number where a consumer 110 can call (to lodge a complaint about a store), or product support for help with a product on how to use the product or how to receive help on getting the product fixed.

.com refers to a service configured for sales via the internet (e.g., an internet website). As used herein, transactions such as ordering and reordering of products via an internet-based network are referred to as “online” transactions.

Optical is a retail area of the retail provider that permits the consumer to order and automatically reorder glasses, contact lenses, or the like products and/or services using the systems and methods described herein.

POS (QR addition) refers to a service configured to allow the consumer 110 to scan a QR code of an item that may be available for sale by the retail provider that would pull up additional information about an item, a service or a number of other types of information relative to where the QR code is located. In some embodiments, Quick Response codes are two-dimensional images that use a scanning app, an image sensor and system processor of the electronic computing device 120 to align small squares with larger position markers. When these markers line up, the mobile device reads and displays the digital information embedded in the QR code. QR codes can be comprised of different zones that feed scanning apps information about a specific product and the code itself. In some embodiments, the large square or squares in a QR code are position markers at the edges of the code and the smaller square or squares in a QR's lower-right-hand corner is an alignment marker, a reference point for the scanner. In addition, QR codes can use strips of alternating black and white modules called “timing patterns” to define rows and columns and markers to define the format of the digital information in the QR, such as websites, numbers and foreign characters. The more modules in a QR coder, the higher its version number. Generally, QR codes can hold up to 100 times more data than conventional one-dimensional bar codes.

Restaurant/Small Business refers to areas of the retail provider's brick-and-mortar location leased by business not directly operated by the retail provider (e.g., a restaurant, hair and/or nail salon, or the like). In some embodiments, the consumer 110 may order and automatically reorder products and/or services from such restaurants/small businesses using the systems and methods described herein.

Click n Pull Renewal refers to a service configured to allow the consumer 110 to preorder products from the retail provider and the retail provider will gather the list of products and have the products available for consumer's pickup at time designated by the consumer 110 at the retail provider's brick-and-mortar location. Membership Services refers to a service configured to offer certain benefits to consumers 110 who have purchased a membership with the retail provider. Such membership may permit the consumer 110 to order and automatically reorder products and/or services offered by the retail provider based on a membership subscription including but not limited to automotive buying, insurance, roadside assistance and other benefits.

In the embodiment illustrated in FIG. 1, the database services 150 are collections of information stored electronically on databases owned and/or operated by the retail provider. Some of the database services 150 can be web services running “in the cloud” and provide a relational database for use in a particular application. With reference to FIG. 1, the exemplary business services 170 can be any consumer, partner or user-facing group of applications, middleware, security, storage, networks and other supporting infrastructure that comes together to enable a comprehensive, end-to-end business process, transaction or exchange of information. These services are characterized by representing a direct value to consumers 110, such as provisioning emailing facilities and internet access. Some examples include, but are not limited to, delivery of financial services to customers of a bank, or goods to the customers of a retail store. Successful delivery of business services often depends on one or more information technology (IT) services. To that end, in some embodiments, a business service 170 may be substantially comprised an IT service, an example being an online banking service or an external website where product orders can be placed by business customers.

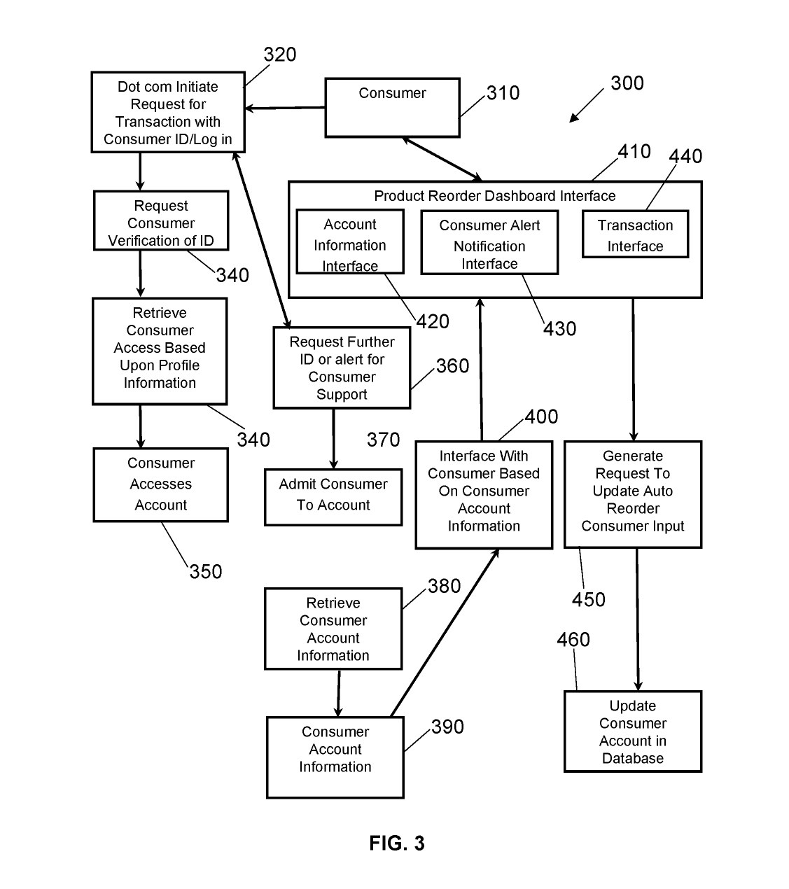

A flow chart illustrating an exemplary embodiment of a system 300 for automatically reordering products for a consumer in operation is depicted in FIG. 3. The system 300 may be available via desktop-based electronic computing devices 120 using desktop-based (e.g., Windows or Mac) operating systems, or via mobile-based electronic computing devices using mobile-based operating systems such as IOS and Android. As shown in step 320 of FIG. 3, a consumer 310 having a previously established account with a retail provider may initially connect to the system 300 via dot.com access (e.g., via the retail provider's dedicated website) by using a unique identification (ID), for example, a unique login/password combination selected by the consumer 310 when establishing the consumer's account with the retail provider. Generally, when a consumer 310 initially sets up an account with the retail provider, the system 300 is configured to permit the consumer 310 to generate a consumer profile including personal information of the consumer 310 (e.g., name, address, phone number, and the like), payment method (e.g., credit card information), as well as the access rights of the consumer 310 (e.g., what products may or may not be bought when logged into the account). The personal information of the consumer 310 and the product rights of the consumer 310 may then be stored in the consumer information database 140 for subsequent retrieval by the central server 130 (e.g., in response to a login request by the consumer 310).

In step 330, as the consumer 310 is connecting to the retail provider's website (e.g., via a login interface), the retail provider's central server 130 may request verification of the ID of the consumer 310. Upon verification of the identity of the consumer 310 (e.g., by comparing the username/password data entered by the consumer 310 into the login interface against username/password data in the profile of the consumer 310 stored in the consumer information database 140), the central server 130 may then associate the consumer profile with the identity of the consumer 310, retrieve the consumer profile from the consumer information database 140, and retrieve the access rights of the consumer 310 based on information stored in the profile of the consumer 310 (step 340). With the access rights of the consumer 310 retrieved by the central server 310, the consumer 310 is permitted to access the consumer's account and get access to the customer information database 140 (step 350).

In some embodiments, the central server 130 may be optionally configured to request further identification from the consumer, for example, to permit the consumer 310 to gain certain level of access rights to purchase products or gain access to the order/reorder management features (e.g., product reorder interface) of the account (step 360). The central server 130 may also be optionally configured to generate an alert for consumer support (e.g., in the event that the consumer 310 is having an issue logging into the consumer's account). Such an alert for consumer support may facilitate the consumer 310 to successfully log in to the system 300 (step 360). If further identification is not required or correctly provided by the consumer 310, or if a customer support alert is not generated, a consumer 310 whose identity is verified by the system 300 may be then permitted access to the consumer's account (step 370).

With reference to FIG. 3, after the consumer 310 is permitted access to the consumer's account in step 370, the central server 130 is configured to retrieve the account information of the customer 310 (step 380). The account information of the consumer 310 may be retrieved by the central server 130 from the central database 140 (step 390) and the account information of the customer 310 retrieved by the central server 130 from the central database 140 may be then sent from the central server 130 to a graphical interface that is displayed to the consumer (step 400), for example, on the electronic computing device 120. In the exemplary embodiment shown in FIG. 3, the graphical interface displayed to the consumer 310 on the electronic computing device 120 is the graphical product reorder dashboard interface 410, which may include one or more menu options and/or sub-interfaces, some of which are discussed in more detail below, that may permit the consumer 310 to customize the customer's account information, alert notification, and product reorder settings as discussed in more detail below.

In the exemplary embodiment illustrated in FIG. 3, the product reorder dashboard interface 410 is a software-implemented graphical interface 410 configured to be displayed on the electronic computing device 120 and including a graphical account information interface 420, a graphical customer alert notification interface 430, and a graphical transaction interface 440. It will be appreciated that the graphical product reorder dashboard interface 410 may be configured to include three separate graphical interfaces 420, 430, and 440 as shown in FIG. 3, or may be configured to include a single graphical interface or on-screen menu incorporating all three of the interfaces 420, 430, and 440. It will also be appreciated that the product reorder dashboard interface 410 may alternatively be configured to include less than three or more than three graphical interfaces presented to the consumer 310 for configuration and personalization of the consumer's product reorder settings.

In some embodiments, the account information interface 420 of the product reorder dashboard interface 410 may be configured to permit the consumer 310 to enter, change, and/or update various personal information associated with the consumer 310, including but not limited to: username and password for access to the system 300; first and last name; shipping address; phone number; payment preferences; credit card number and expiration date; credit card billing address, or the like. For example, the account information interface 420 may be configured to include graphical text input fields that permit the consumer 310 to enter and modify the consumer's personal information, for example, by using inputs 270 that may be displayed (e.g., an on-screen keyboard) on the display 260 of the electronic computing device 120, or a physical keyboard coupled to the electronic computing device 120. In response to the consumer 310 entering and/or changing the consumer's personal information via the account information interface 420, the electronic computing device 120 may be configured to send a request to the central server 130 to update the consumer information database 140 to reflect the changes made to the personal information of the consumer 310. The central server 130 may be configured, upon receipt of such a request from the electronic computing device 120, to update the account information of the consumer 310 in the consumer information database 140.

In some embodiments, the customer alert notification interface 430 of the product reorder dashboard interface 410 may be configured to display various notifications from the retail provider to the consumer 310. Such consumer alert notifications may be, for example, sent form the central server 130 (or a server remote to the central server 130) to the electronic computing device 120 of the consumer 310. Some exemplary consumer alert notifications 430 may include but are not limited to: notification of upcoming expiration date of the credit card on file of the consumer 310, notification of upcoming expiration date of a prescription for medication of the consumer 310; notification of renewal or discontinuation of a product previously ordered by the consumer 310; notification that a product on the product reorder list of the consumer 310 is out of stock; notification of availability of one or more retail provider-selected or consumer-preselected product substitutes if the first-choice product in the product reorder shopping cart of the consumer 310 is not available as a result of being out-of-stock, discontinued, or the like; notification of additions to/deletions from the favorite product list of the consumer 310; notification of shipment and/or delivery of a product ordered by the consumer 310; notification of shipment of a product automatically reordered for the consumer 310 via the system 100 based on the product reorder settings of the consumer 310; notification of shopping history of the consumer 310 for a predetermined period of time (e.g., 1 month, 3 months, 6 months, 12 months, or from the first day the consumer signed up for an account with the retail provider); and notification of availability of recommended products and/or services for the consumer 310, including but not limited to: coupons, sale offers, and/or one or more products specifically targeted to the consumer 310 based on at least one product in the consumer's product reorder shopping list, and/or the consumer's shopping history, and/or at least one product in the shopping cart of the consumer 310 and/or the personal information of the consumer 310. Such recommended products and/or services, and in particular, the specific targeted advertising of recommended products to the consumer 310 in addition to the products already in the consumer's product reorder shopping list may advantageously increase the revenue stream for the retail provider.

In some embodiments, the transaction interface 440 of the product reorder dashboard interface 410 may be configured to permit the consumer 310 to enter, change, and/or update the product reorder preferences of the consumer 310. For example, the transaction interface 440 of the product reorder dashboard interface 410 may be configured to permit the consumer 310 to create and/or modify a virtual (e.g., graphical) shopping cart and to add to the shopping cart one or more products that the consumer 310 is interested in placing an order for using the system 300. The transaction interface 440 of the product reorder dashboard interface 410 may be also configured to permit the consumer 310 to create and/or modify a product reorder shopping list including one or more previously ordered products that the consumer 310 is presently interested in being automatically reordered via the system 300. In addition, the transaction interface 440 of the product reorder dashboard interface 410 may be configured to permit the consumer 310 to create a favorite products list and to add and/or remove one or more products of interest to/from the consumer's favorite products list.

In some embodiments, the transaction interface 440 of the product reorder dashboard interface 410 may be configured to permit the consumer 310, while not being physically present at the brick-and-mortar retail facility of the retail provider, to manually add a product of interest to the consumer's shopping cart and/or favorites list and/or product reorder list by manually entering identifying information associated with the product into a text input field in the graphical transaction interface 440 displayed on the electronic computing device 120, with the addition of the product of interest to the consumer's shopping cart and/or favorites list and/or product reorder list being communicated from the electronic computing device 120 via an internet connection to the central server 130 for storage in the consumer database 140. In other embodiments, the graphical transaction interface 440 of the graphical product reorder dashboard interface 410 may include or be operatively coupled to a product indicia code reader (e.g., QR code reader, bar code reader, or the like) to permit the consumer 310, while physically present at the brick-and-mortal retail location of the retail provider, to add and/or delete a product of interest to/from the shopping cart and/or favorites list and/or product reorder shopping list by scanning identifying indicia (e.g., QR code, bar code, or the like) on the product of interest using the electronic computing device 120 of the consumer 310.

In some embodiments, the shopping cart of the consumer and/or the product reorder shopping list of the consumer 310 may be stored in the consumer information database 140 on the central server 130. The transaction interface 440 of the product reorder dashboard interface 410 may be configured to permit the consumer 310 to modify the product reorder shopping list of the consumer 310 by adding one or more products previously ordered by the consumer 310 to the product reorder shopping list or removing one or more previously ordered products from the product reorder shopping list, and to update the account information of the consumer 310 by saving the modified product reorder shopping list of the consumer 310 in the consumer information database 140 stored on the central server 130. For example, when the consumer 310 modifies the consumer's product reorder shopping list (examples of exemplary modifications are illustrated below), the transaction interface 440 of the product reorder dashboard interface 410 may be configured to cause the electronic computing device 120 to send the consumer's modifications to the product reorder list to the central server 130, such that the account information of the consumer 310 in the consumer information database 140 on the central server 130 can be updated to reflect the consumer's changes to the product reorder list.

In some embodiments, the transaction interface 440 of the product reorder dashboard interface 410 may be configured to permit the consumer to modify the product reorder settings of the consumer 310 by setting and/or modifying a predetermined time interval for automatic reordering of one or more products previously ordered by the consumer 310 and to modify the predetermined time interval for the automatic reordering of the one or more products previously ordered by the consumer 310. For instance, the consumer 310 may use the transaction interface 440 of the product reorder dashboard interface 410 to set a time interval of 30 days for automatically reordering the consumer's prescription medications, or set a time interval of 90 days for automatically reordering the consumer's preferred floor cleaning product.

In some embodiments, the transaction interface 440 of the product reorder dashboard interface 410 may be configured to permit the consumer 310 to modify the consumer's product reorder settings by setting and/or modifying a predetermined number of the one or more previously ordered products to be automatically reordered via the system 300. For instance, the consumer may use the transaction interface 440 of the product reorder dashboard interface 410 to set product reorder settings calling for automatic reordering of 30 bottles of water or calling for automatic reordering of 4 case packs of paper towels. The transaction interface 440 of the product reorder dashboard interface 410 may be configured to cause the electronic computing device 120 to send the consumer's product reorder settings to the central server 130 in order to update the consumer information database 140 to reflect the consumer's updated product reorder settings.

The transaction interface 440 of the product reorder dashboard interface 410 may be likewise configured to permit the consumer 310 to modify the consumer's product reorder settings by setting one or more alert notifications associated with one or more of the products previously ordered by the consumer 310. For example, in some embodiments, such alert notifications may be configured to remind the consumer 310 that one or more of the products previously ordered by the consumer 310 should be reordered. In some embodiments, such alert notifications may be configured to notify the consumer 310 that one or more of the previously ordered product were automatically reordered via the system 300 based on the consumer's reorder settings. In some embodiments, the transaction interface 440 of the product reorder dashboard interface 410 may be configured to permit the consumer 310 to enter the expiration date of the consumer's previously purchased prescription medication such that an alert may be generated for the consumer 310 at or near the entered expiration date to notify the consumer 310 to reorder the prescription. Alternatively, the prescription may be automatically reordered by the system 300 based on the product reorder settings of the consumer 310 as described above.

In the exemplary embodiment shown in FIG. 3, the reorder dashboard 410 may be configured to generate a request to the central server 130 to change and/or update the automatic reorder settings of the consumer 310 (step 450). In response to such a request, the central server 130 is configured to update the personal information of the consumer 310 in the consumer information database 140 (step 460) to reflect the consumer's changes to the automatic product reorder settings of the consumer 310.

In some embodiments, the transaction interface 440 of the product reorder dashboard interface 410 may be configured to permit the consumer 110 to enter one or more acceptable product substitutes in the event that the consumer's first-choice product in the product reorder shopping list of the consumer 310 is not available (e.g., out-of-stock, discontinued, or the like). The transaction interface 440 of the product reorder dashboard interface 410 may be configured to cause the electronic computing device 120 to send the consumer's indications of one or more substitute products to the central server 130 in order to update the consumer information database 140 to reflect the consumer's substitute products. Then, in response to a determination that the consumer's previously ordered first-choice product on the consumer's product reorder shopping list is not available to be automatically reordered, the product reorder dashboard interface 410 to automatically order the at least one alternative product.

In addition, in some embodiments, the transaction interface 440 of the reorder dashboard 410 may be configured to permit the consumer 310 to create, modify and/or delete the consumer's favorite product lists indicating the most preferred and/or most often ordered or reordered products by the consumer 110, as well as historical lists indicating the past product purchases of the consumer 110 from the retail provider. In some embodiments, the graphical product reorder dashboard interface 410 may include at least one input field and/or clickable link and/or selectable icon configured to permit the consumer 310 to share the consumer's shopping cart and/or favorite products list and/or product reorder shopping list with one or more other people via social media (e.g., Facebook, Twitter, Instagram, or the like) and/or electronic mail.

In some embodiments, the system 300 may be configured to automatically reorder products previously ordered by the consumer 310 based upon the product reorder preferences of the consumer 310 with respect to predetermined time intervals, prescription expirations, or cost considerations. For example, the consumer 310 can browse through and select alternative or substitute products for automatic reordering in the event the primary product of interest to the consumer 310 is not available. In addition, the system 300 permits the consumer 310 to sort the products of interest for replenishment via automatic reordering based upon coupons, sales events, and other savings offered by the retail provider to create a recurring product reorder shopping list. In addition, the product reorder dashboard interface 410 is configured to permit the consumer 310 to review the consumer's previous shopping experiences with the retail provider through review of the consumer's purchase history and then make changes if desired.

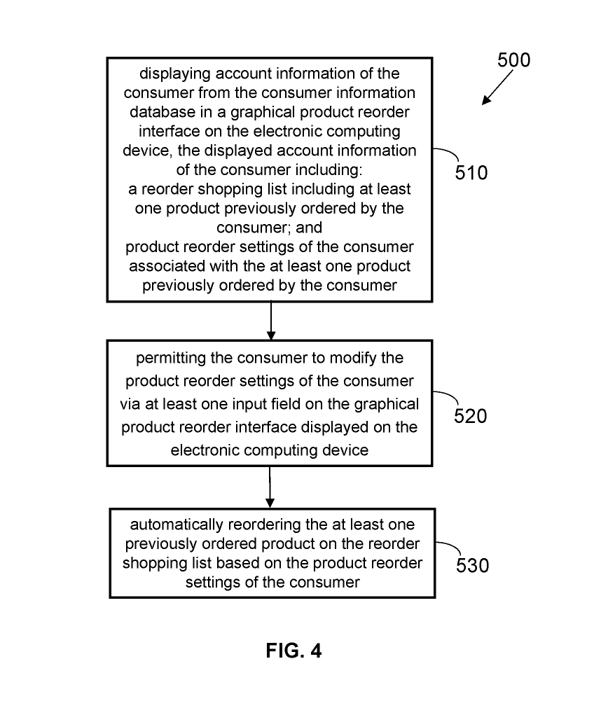

Referring to FIGS. 1 and 4, an exemplary method 500 of assisting a consumer 110 in automatically reordering products previously ordered from a retail provider using an electronic computing device 120 is shown. Step 510 of the exemplary method 500 shown in FIG. 4 includes displaying on the electronic computing device 120 account information of the consumer 110 from a consumer information database 140 in a graphical product reorder interface (e.g., product reorder dashboard 410). In the embodiment depicted in FIG. 4, the displayed account information of the consumer 110 may include a reorder shopping list of the consumer 110 (e.g., including one or more products previously ordered by the consumer 110) and product reorder settings of the consumer 110 associated with the one or more products previously ordered by the consumer 110. In some embodiments, as described above, the reorder shopping list may be displayed to the consumer 110 on the electronic computing device 120 via the transaction interface 440 of the product reorder dashboard interface 410, while the product reorder settings of the consumer 110 may be displayed to the consumer 110 on the electronic computing device 120 via the account information interface 420 of the product reorder dashboard interface 410.

In the exemplary embodiment of FIG. 4, as the product reorder settings of the consumer 110 are displayed to the consumer 110 on the electronic computing device 120 (e.g., via the account information interface 420 of the product reorder dashboard interface 410), the product reorder dashboard interface 410 is configured such that the method includes permitting the consumer 110 to modify the consumer's product reorder settings via at least one input field on the graphical product reorder dashboard interface 410 displayed to the consumer 110 on the electronic computing device 120 (step 520).

As described above, such input fields in the product reorder dashboard interface 410 are configured to permit the consumer 110 to enter text representing the consumer's preferred reorder settings for a product into the graphical product reorder interface 410, thereby causing a product reorder list of the consumer and/or the product reorder settings of the consumer to be sent to the central server 130, saved in the consumer information database 140, and subsequently retrieved from the consumer information database 140 to facilitate automatic reordering of one or more of the products previously ordered by the consumer 110 based on the product reorder shopping list of the consumer and/or the product reorder settings of the consumer. In the exemplary method shown in FIG. 4, with the product reorder settings of the consumer 110 associated with one or more products entered into the product reorder dashboard interface 410, the method further includes automatically reordering the one or more of the previously ordered products on the reorder shopping list based on the product reorder settings of the consumer 110.

The systems and methods described herein provide for easy creation and personalization product reorder settings by consumers and automatic product reordering based on the consumers' preset product reorder settings. In addition, the systems and methods described herein advantageously provide for customization and personalization of the consumers' shopping process, allowing the consumers to create favorite shopping lists, modify their reorder preferences, automatically receive products based on the reorder preferences, and receive alerts that may both offer price discounts to the consumers and specifically targeted products of interest to the consumers. As such, the systems and methods described herein may advantageously save consumers time and money when ordering and reordering products from internet-based and brick-and-mortar-based retail providers, simultaneously increasing the revenue streams for the retail providers.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A method for assisting a consumer in automatically reordering previously ordered products using an electronic computing device, the method comprising:
displaying account information of the consumer from a consumer information database in a graphical product reorder interface on the electronic computing device, the displayed account information of the consumer including:
a reorder shopping list including at least one product previously ordered by the consumer; and
product reorder settings of the consumer associated with the at least one product previously ordered by the consumer;
permitting the consumer to modify the product reorder settings of the consumer via at least one input field on the graphical product reorder interface displayed on the electronic computing device; and
automatically reordering the at least one previously ordered product on the reorder shopping list based on the product reorder settings of the consumer.

2. The method of claim 1, further comprising permitting the consumer to modify the reorder shopping list by adding at least one additional product or removing the at least one previously ordered product, and updating the account information of the consumer by saving the modified reorder shopping list in the consumer information database.

3. The method of claim 1, further comprising permitting the consumer to modify the product reorder settings of the consumer by at least one of:
setting a predetermined time interval for the automatic reordering of the at least one previously ordered product, and permitting the consumer to modify the predetermined time interval for the automatic reordering of the at least one previously ordered product;
setting a predetermined number of the at least one previously ordered product to be automatically reordered, and permitting the consumer to modify the predetermined number of the at least one previously ordered product to be automatically reordered; and
creating an alert notification associated with the at least one previously ordered product, the alert notification being configured to at least one of remind the consumer that the at least one previously ordered product should be reordered and notify the consumer that the at least one previously ordered product was automatically reordered.

4. The method of claim 1, further comprising receiving, at a server separate from the electronic computing device and coupled to the consumer information database, a request from the electronic computing device to modify the product reorder settings of the consumer.

5. The method of claim 4, further comprising updating the account information of the consumer by modifying the product reorder settings of the consumer in the consumer information database in response to the request received from the electronic computing device.

6. The method of claim 1, further comprising permitting the consumer to add at least one additional product of interest to the reorder shopping list via scanning an identifying characteristic of the at least one additional product of interest using the electronic computing device at the retail sales facility.

7. The method of claim 1, further comprising permitting the consumer to select, via the graphical product reorder interface, at least one alternative product to the at least one product previously ordered by the consumer and, in response to a determination that the at least one previously ordered product being automatically reordered is not available, automatically ordering the at least one alternative product.

8. The method of claim 1, further comprising generating product recommendations to the consumer based on the at least one product on the reorder shopping list and displaying the generated product recommendations in the graphical product reorder interface on the electronic computing device to the consumer for selection.

9. The method of claim 1, wherein the displaying step further comprises displaying at least one input field in the graphical product reorder interface on the electronic computing device configured to permit the consumer to share the reorder shopping list of the consumer with one or more other consumers via one of social media and electronic mail.

10. The method of claim 1, further comprising permitting the consumer to generate a consumer profile including product access rights of the consumer, associating the generated consumer profile with the identity of the consumer, storing the generated consumer profile in the consumer information database, and retrieving the consumer profile from the consumer information database in response to a verification of the identity of the consumer.

11. A system for assisting a consumer in automatically reordering previously ordered products, the system comprising:
a consumer information database configured to store consumer information;
an electronic computing device including a processor and configured to communicate with the consumer information database via a communication network, the electronic computing device configured to:
retrieve account information of the consumer from the consumer information database;
display the account information of the consumer received from the consumer information database in a graphical product reorder interface, the displayed account information of the consumer including:
a reorder shopping list including at least one product previously ordered by the consumer; and
product reorder settings of the consumer associated with the at least one product previously ordered by the consumer;
permit the consumer to modify the product reorder settings of the consumer via at least one input field on the displayed graphical product reorder interface; and
automatically reorder the at least one previously ordered product on the reorder shopping list based on the product reorder settings of the consumer.

12. The system of claim 11, wherein the graphical product reorder interface is configured to permit the consumer to modify the reorder shopping list by adding at least one additional product or removing the at least one previously ordered product, and to update the account information of the consumer by saving the modified reorder shopping list in the consumer information database.

13. The system of claim 11, wherein the graphical product reorder interface is configured to permit the consumer modify the product reorder settings of the consumer by setting at least one of:
a predetermined time interval for the automatic reordering of the at least one previously ordered product, and permit the consumer to modify the predetermined time interval for the automatic reordering of the at least one previously ordered product;
a predetermined number of the at least one previously ordered product to be automatically reordered, and permit the consumer to modify the predetermined number of the at least one previously ordered product to be automatically reordered; and
an alert notification associated with the at least one previously ordered product, the alert notification being configured to at least one of remind the consumer that the at least one previously ordered product should be reordered and notify the consumer that the at least one previously ordered product was automatically reordered.

14. The system of claim 11, wherein the electronic computing device is configured to send a request to a server separate from the electronic computing device and coupled to the consumer information database to modify the product reorder settings of the consumer.

15. The system of claim 14, wherein the server is configured, upon receipt of the request from the electronic computing device, to update the account information of the consumer and modify the product reorder settings of the consumer in the consumer information database.

16. The system of claim 11, wherein the graphical product reorder interface is configured to add at least one additional product of interest to the reorder shopping list via scanning an identifying characteristic of the at least one additional product of interest using the electronic computing device at the retail sales facility.

17. The system of claim 11, wherein the graphical product reorder interface is configured to permit the consumer to select, via the graphical product reorder interface, at least one alternative product to the at least one product previously ordered by the consumer and, in response to a determination that the at least one previously ordered product being automatically reordered is not available, automatically order the at least one alternative product.

18. The system of claim 11, wherein the graphical product reorder interface is configured to display product recommendations to the consumer for selection, the product recommendations being generated based on the at least one product on the reorder shopping list.

19. The system of claim 11, wherein the graphical product reorder interface is configured to include at least one input field configured to permit the consumer to share the reorder shopping list of the consumer with one or more other consumers via one of social media and electronic mail.

20. The system of claim 11, wherein the graphical product reorder interface is configured to permit the consumer to generate a consumer profile including product access rights of the consumer, the first server is configured to associate the generated consumer profile with the identity of the consumer, the consumer information database is configured to store the generated consumer profile, and the first server is configured to retrieve the consumer profile from the consumer information database in response to a verification of the identity of the consumer.

21. A system for assisting a consumer in automatically reordering previously ordered products, the system comprising:
a database means configured to store consumer information;
an processing means configured to communicate with the consumer information database via a communication network, the processing means configured to:
retrieve account information of the consumer from the consumer information database;
display the account information of the consumer received from the consumer information database in a graphical product reorder interface, the displayed account information of the consumer including:
a reorder shopping list including at least one product previously ordered by the consumer; and
product reorder settings of the consumer associated with the at least one product previously ordered by the consumer;
permit the consumer to modify the product reorder settings of the consumer via at least one input field on the displayed graphical product reorder interface; and
automatically reorder the at least one previously ordered product on the reorder shopping list based on the product reorder settings of the consumer.
